(19) United States
(12) Patent Application Publication
(10) Pub. No.: US 2002/0136401 A1
(43) Pub. Date: Sep. 26, 2002

(54) Digital signature and authentication method and apparatus

(76) Inventors: Jeffrey Hoffstein, Pawtucket, RI (US); Jill Pipher, Pawtucket, RI (US); Joseph H. Silverman, Needham, MA (US)

Correspondence Address: EDWARDS & ANGELL, LLP, Dike, Bronstein, Roberts & Cushman, Intellectual Property Practice Group, 130 Water Street, Boston, MA, 02109, US

(21) Appl. No.: 09/812,917

(22) Filed: Mar. 20, 2001

Related U.S. Application Data
(60) Provisional application No. 60/220,668, filed on Jul. 25, 2000.

(51) Int. Cl. H04K 1/00

(52) U.S. Cl. 380/30; 380/28

(57) ABSTRACT

Methods, systems and computer readable media for signing and verifying a digital message m are described. First, ideals p and q of a ring R are selected. Elements f and g of the ring R are generated, followed by generating an element F, which is an inverse of f, in the ring R. A public key h is produced, where h is equal to a product that can be calculated using g and F. Then, a private key that includes f is produced. A digital signature s is signed to the message m using the private key. The digital signature is verified by confirming one or more specified conditions using the message m and the public key h. A second user also can authenticate the identity of a first user. A challenge communication that includes selection of a challenge m in the ring R is generated by the second user. A response communication that includes computation of a response s in the ring R, where s is a function of m and f, is generated by the first user. A verification that includes confirming one or more specified conditions using the response s, the challenge m and the public key h is performed by the second user. Also described are methods, systems and computer readable media for authenticating the identity of a first user by a second user using similar technology.

### FIELD OF THE INVENTION

The present invention relates generally to secure communication and document identification over computer networks or other types of communication systems and, more particularly, to secure user identification and digital signature techniques based on rings and ideals. The invention also has application to communication between a card, such as a “smart card”, or other media, and a user terminal.

### BACKGROUND OF THE INVENTION

User identification techniques provide data security in a computer network or other communications s ,stem by allowing a given user to prove its identity to one or more other system users before communicating with those users. The other system users are thereby assured that they are in fact communicating with the given user. The users may represent individual computers or other types of terminals in the system. A typical user identification process of the challenge-response type is initiated when one system user, referred to as the Prover, receives certain information in the form of a challenge from another system user, referred to as the Verifier. The Prover uses the challenge and the Prover's private key to generate a response, which is sent to the Verifier. The Verifier uses the challenge, the response and a public key to verify that a legitimate Prover generated the response. The information passed between the Prover and the Verifier is generated in accordance with cryptographic techniques that insure that eavesdroppers or other attackers cannot interfere with the identification process.

It is well known that a challenge-response user identification technique can be converted to a digital signature technique by the Prover utilizing a one-way hash function to simulate a challenge from a Verifier. In such a digital signature technique, a Prover applies the one-way hash function to a message to generate the simulated challenge. The Prover then utilizes the simulated challenge and a private key to generate a digital signature, which is sent along with the message to the Verifier. The Verifier applies the same one-way hash function to the message to recover the simulated challenge and uses the challenge and a pub ic key to validate the digital signature.

One type of user identification technique relies on the one-way property of the exponentiation function in the multiplicative group of a finite field or in the group of points on an elliptic curve defined over a finite field. This technique is described in U.S. Pat. No. 4,995,082 and in C. P. Schnorr, “Efficient Identification and Signatures for Smart Cards,” in G. Brassard, ed., Advances in Cryptology—Crypto '89, Lecture Notes in Computer Science 435, Springer-Verlag, 1990, pp. 239-252. This technique involves the Prover exponentiatir g a fixed base element g of the group to some randomly selected power k and sending it to the verifier. An instance of the Schnorr technique uses two prime numbers p and q chosen at random such that q divides p−1, and a number g of order q modulo p is selected. The numbers p, q, and g are made available to all users. The private key of the Prover is x modulo q and the public key y of the Prover is g^{-x} modulo p. The Prover initiates the identification process by selecting a random non-zero number z modulo q. The Prover computes the quantity g^{z} modulo p and sends it as a commitment to the Verifier. The Verifier selects a random number w from the set of integers {1,2, . . . ,2^{t}} where t is a security number which depends on the application and in the above-cited article i; selected as 72. The Verifier sends w as a challenge to the Prover. The Prover computes a quantity u that is equal to the quantity z+xw modulo q as a response and sends it to the Verifier. The Verifier accepts the Prover as securely identified if g^{z} is found to be congruent modulo p to the quantity g^{u}y^{z}.

Another type of user identification technique relies on the difficulty of factoring a product of two large prime numbers. A user identification technique of this type is described in L. C. Guillou and J. J. Quisquater, “A Practical Zero-Knowledge Protocol Fitted to Security Micro processor Minimizing Both Transmission and Memory,” in C. G. Gunther, Ed. Advances n Cryptology—Eurocrypt '88, Lecture Notes in Computer Science 330, Springer-Verlag, 1988, pp. 123-128. This technique involves a Prover raising a randomly selected argument g to a power b modulo n and sending it to a Verifier. An instance of the Guillou-Quisquater technique uses two prime numbers p and q selected at random, a number n generated as the product of p and q, and a large prime number b also selected at random. The numbers n and b are made available to all users. The private key of the Prover is x modulo n and the public key y of the Prover is x^{-b} modulo n. The Prover initiates the identification process by randomly selecting the as the response. The Verifier accepts the Prover as securely identified if the polynomial h(X) has small coefficients and if the formula

h(b)=c₁(b)f₁(b)+c₂(b)f₁(b)g₂(b)+c₃(b)f₂(b)g₁(b)+c₄(b)f₂(b)g₂(b) (mod q)

is true for every value of b in S.

Although the above-described Schnorr, Guillou-Quisquater, and Hoffstein-Lieman-Silverman techniques can provide acceptable performance in many applications, there is a need for an improved technique which can provide greater computational efficiency than these and other prior art techniques, and which relies for security on features other than discrete logarithms, integer factorization, and polynomial evaluation.

International Patent Publication WO98/08323 and U.S. Pat. No. 6,081,597 describe a public key encryption system, called “NTRU”, that can be used to encode and decode a message. That system has short and easily created encryption keys, has encoding and decoding processes that can be performed rapidly, and has low memory requirements. The production of the keys and the encoding operation to encode a digital message m can include the following:

selecting integers p and q;

generating polynomials f and g;

determining inverses F_{q} and Fₚ, where

F_{q} * f=1(mod q)

Fₚ * f=1(mod p);

producing a public key that includes p, q and h, where

h=F_{q}* g (mod q);

producing a private key that includes f and Fₚ; and

producing an encoded message e by encoding the message m in the form of a polynomial using the public key and a random polynomial Φ. The owner of the private key using the encoded message and the private key can then decode the encoded message.

Although the NTRU public key encryption system has certain advantageous aspects, its advantages have not been realized heretofore in the form of a digital signature technique, nor in the form of a challenge/response authentication technique.

Both public key encryption schemes and digital signature schemes use a public key and a private key. However, even though those keys may have the same form, they are used in different ways and for different purposes in a public key encryption scheme and a digital signature scheme.

In public key encryption, the public key is used to encode a message and the private key is used to decode the encoded message. Generally, the way that a public key encryption scheme works is that the private key contains some secret information and only one possessing that secret information can decode messages that have been encoded using the public key, which is formulated in part based on that secret information.

In a digital signature technique, the private key is used to sign a digital document and, then, the public key is used to verify or to validate the digital signature. That is opposite to the manner in which the keys are used in an encryption technique.

It has been recognized that some public key encryption schemes, by their nature, can readily be turned into digital signature schemes. One example is the RSA encryption scheme. However, other types of public key encryption schemes, such as probabilistic encryption schemes, are not readily turned into digital signature schemes. The idea of a probabilistic encryption scheme is that the encryption process also uses some random data to encode the message. (See, S. Goldwasser and A. Micali, “Probabilistic Encryption,” J. Computer and Systems Science, 28 (1984), 270-299.) That random data is an intrinsic part of the encryption process, so the encoded message depends on the original message and also on the random data. It is important to note that, if the same message is transmitted twice, the two encrypted messages will look very different because of the random data. That added randomness may make it more difficult for an attacker to break the code and read the encrypted messages. However, it also means that the encryption/decryption process cannot be performed in the reverse order.

### SUMMARY OF THE INVENTION

The present invention provides a method, system and apparatus for performing user identification, digital signatures and other secure communication functions using a random data component Keys are chosen essentially at random from a large set of vectors and key size is comparable to the key size in other common identification and digital signature schemes at comparable security levels. The signing and verifying techniques hereof provide substantial improvements in computational efficiency, key size, and/or processing requirements over previous techniques.

In one embodiment, the present invention provides an identification/digital signature scheme where in the signing technique uses a mixing system based on polynomial algebra and on two reduction numbers, p and q, and the verification technique uses special properties of small products whose validity depends on elementary probability theory. The security of the identification/digital signature scheme comes from the interaction of reduction modulo p and modulo q and the difficulty of forming small products with special properties. Security also relies on the experimentally observed fact that, for most lattices, it is very difficult to find a vector whose length is only a little bit longer than the shortest vector.

In accord with one preferred embodiment of the invention, a secure user identification technique s provided in which one of the system users, referred to as the Prover, creates a private key f, which is an element of the ring R, and creates and publishes an associated public key h, which also is an element of the ring R. Another user of the system, referred to as the Verifier, randomly selects a challenge element m from a subset Rₘ of the ring R and transmits m to the Prover. The Prover generates a response element s using the private key f and the element m. The element s is generated in the form f*w modulo q using multiplication (*) in the ring R, where w is formed using the private key f and the challenge element m. The Prover sends the response element s to the Verifier. The Verifier checks that the element s differs modulo p from the element e_{f}*m in an acceptable number of places and that the element t=h * s modulo q differs modulo p from the product e_{g}* m in an acceptable number of places, where e_{f} and e_{g} are fixed elements of the ring R. If these conditions are satisfied, then, the Verifier accepts the identity of the Prover. The Verifier uses the above-noted comparison for secure identification of the Prover, for authentication of data transmitted by the Prover, or for other secure communication functions.

In accord with another preferred embodiment of the invention, a digital signature technique is provided. In this embodiment, a Prover applies a hash function to a message M to generate a challenge element m=Hash(M) in the set Rₘ. The Prover uses m and f to generate a signature element s. The element s can be generated in the form f * w modulo q using multiplication (*) in the ring R, where w is formed using the private key f and the challenge element m. The Prover publishes the message M and the signature s. The Verifier checks that the element s differs modulo p from the element e_{f}* m (where m is generated by the Verifier as the hash of M, i.e., m=Hash(M)) in an acceptable number of places and that the element t=h * s modulo q differs modulo p from the product e_{g}* m in an acceptable number of places, where h is the public key and each of e_{g} and e_{f} is a fixed predetermined element of the ring R. If these conditions are satisfied, then the Verifier accepts the signature of the Prover on the message M.

The present invention also provides a computer readable medium containing instructions for performing the above-described methods of the invention.

A system for signing and verifying a digital message m, in accord with one embodiment of the present invention, comprises: means for selecting ideals p and q of a ring R; means for generating elements f and g of the ring R; means for generating an element F, which is an inverse of f, in the ring R; means for producing a public key h, where h is equal to a product that can be calculated using g and F; means for producing a private key that includes f; means for producing a digital signature s by digitally “signing” the message m using the private key; and means for verifying the digital signature by confirming one or more specified conditions using the message m and the public key h.

In accord with another embodiment of the invention, a system for signing and verifying a digital message m comprises: means for selecting integers p and q; means for generating polynomials f and g; means for determining the inverse F, where F f=1 (mod q); means for producing a public key h, where h=F * g (mod q); means for producing a private key that includes f; means for producing a digital signature s by digitally signing the message m using the private key; and means for verifying the digital signature by confirming one or more specified conditions using the message m, the public key h, the digital signature s, and the integers p and q.

In accord with a further embodiment of the invention, a system for authenticating the identity of a first user by a second user including a challenge communication from the second user to the first user, a response communication from the first user to the second user, and a verification by the second user, comprises: means for selecting ideals p and q of a ring R; means for generating elements f and g of the ring R; means for generating an element F, which is an inverse of f, in the ring R; means for producing a public key h, where h is a product that can be produced using g and F; means for producing a private key including f and F; means for generating a challenge communication by the second user that includes selection of a challenge m in the ring R; means for generating a response communication by the first user that includes computation of a response s in the ring R, where s is a function of m and f; and means for performing a verification by the second user that includes confirming one or more specified conditions using the response s, the challenge m and the public key h.

Another embodiment of the present invention provides a system for authenticating the identity of a first user by a second user including a challenge communication from the second user to the first user, a response communication from the first user to the second user, and a verification by the second user, comprising: means for selecting integers p and q; means for generating polynomials f and g; means for determining the inverse F, where F * f=1 (mod q); means for producing a public key h, where h=F * g (mod q); means for producing a private key that includes f, means for generating a challenge communication by the second user that includes selection of a challenge m; means for generating a response communication by the first user that includes computation of a response s, wherein s is produced using m and f; and means for performing a verification by the second user that includes confirming one or more specified conditions using the response s, the challenge m, the public key h, and the integers p and q.

Further features and advantages of the invention will become more readily apparent from the following detailed description when taken in conjunction with the accompanying drawings.

### DEFINITIONS

The following definition is used for purposes of describing the present inventions. A computer readable medium shall be understood to mean any article of manufacture that contains data that can be read by a computer or a carrier wave signal carrying data that can be read by a computer. Such computer readable media includes but is not limited to magnetic media, such as a floppy disk, a flexible disk, a hard disk, reel-to-reel tape, cartridge tape, cassette tape or cards; optical media such as CD-ROM and writeable compact disc; magneto-optical media in disc, tape or card form; paper media, such as punched cards and paper tape; or on carrier wave signal received through a network, wireless network or modem, including radio-frequency signals and infrared signals.

### BRIEF DESCRIPTION OF THE DRAWINGS

FIG. 1 is a flow diagram that illustrates a key creation technique in accordance with an exemplary embodiment of the present invention.

FIG. 2 is a flow diagram that illustrates a user identification technique in accordance with an exemplary embodiment of the present invention.

FIG. 3 is a flow diagram that illustrates a digital signature technique in accordance with an exemplary embodiment of the present invention.

FIG. 4 is a block diagram of a system that can be used in practicing the methods of the present invention.

### DETAILED DESCRIPTION OF THE INVENTION INCLUDING PREFERRED EMBODIMENTS

In accord with the present invention, user identification and digital signature techniques are based on multiplication and reduction modulo ideals in a ring. An exemplary embodiment of the present invention is based on multiplication of constrained polynomials over a finite ring. An exemplary finite ring Z/qZ is defined for an integer q. An exemplary ring R=(Z/qZ)[X]/(X^{N}−1) is a ring of polynomials with coefficients in the finite ring Z/qZ modulo the ideal generated by the polynomial X^{N}−1 for a suitable chosen integer N. An exemplary product in the ring R is the product h(X)=F(X) * g(X), where g(X) is a polynomial with small coefficients and where f(X), the inverse of F(X), in R is a polynomial with small coefficients. With suitable choices of q and N and suitable bounds on the coefficients of f(X) and g(X), it is infeasible to recover f(X) and g(X) when given only h(X). As will be described in greater detail below, this provides a one-way function that is particularly well-suited to use in implementing efficient user identification and digital signatures.

The identification and digital signature techniques of the present invention make use of the multiplication rule in the ring R. Given a polynomial A(X)=A₀+A₁X+. . . +A_{N-2}X^{N-1} in R and a polynomial B(X)=B₀+B₁X+. . .+B_{N-2}X^{N-1} in R, an exemplary product is given by:

C(X)=A(X)B(X)(X)=C₀+C₁X+. . .+C_{N-1}X^{N-1}

where C₀, . . . ,C_{N-1} are given by:

C₁=A₀Bᵢ+A₁Bᵢ₋₁+. . .+aᵢB₀++Aᵢ₊₁B_{N-1}+A₁₊₂B_{N-2}+. . .+A_{N-1}Bᵢ₊₁(modulo q).

All reference to multiplication of polynomials in the remaining description should be understood to refer to the above-described exemplary multiplication in R. It should also be noted that the above-described multiplication rule is not a requirement of the invention, and alternative embodiments can use other types of multiplication rules.

An exemplary set of constrained polynomials R_{f} is the set of polynomials in R with bounded coefficients or, more specifically, the set of polynomials of the form f(X)=e_{f}(X)+pf₁(X), where f₁(X) has very small coefficients, p is a specified integer, and e_{f}*X) is a specified polynomial, for example, e_{f}{X)=1. An exemplary set of constrained polynomials R_{g} is the set of polynomials in R with bounded coefficients or, more specifically, the set of polynomials of the form g(X)=e_{g}(X)+pf₁(X), where g₁(X) has very small coefficients, p is a specified integer, and e_{g}(X) is a fixed specified polynomial, for example e_{g}(X)=1-2X.

Given two constrained polynomials f(X) in R_{f} and g(X) in R_{g}, it is relatively easy to find the inverse of f(X), i.e., F(X)=f(X)⁻¹, in the ring R and to compute the product h(X)=F(X)*g(X). The inverse will exist for most choices of f(X). If the inverse does not exist for a particular choice of f(X), then one chooses another f(X). However, appropriately selected restrictions on the set of constrained polynomials can make it extremely difficult to invert this process and determine polynomials f(X) in R_{f} and g(X) in R_{g} such that f(X)⁻¹ * g(X) is equal to h(X). Establishing appropriate restrictions on the polynomials in R_{f} and R_{g} can provide adequate levels of security.

An exemplary identification technique, in accord with the invention, uses a number of system parameters that are established by a central authority and made public to all users. These published system parameters include the above-noted numbers N, p and q, and the above-noted polynomials e_{f}(X) and e_{g}(X). The system parameters also include appropriate sets of bounded coefficient polynomials R_{f} , R_{g} , R_{w}, Rₛ, Rₜ and Rₘ.

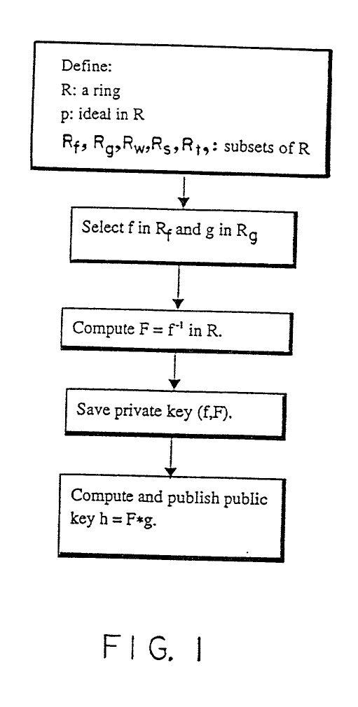

FIG. 1 illustrates the creation of a public/private key pair. After establishment of parameters, a Prover randomly chooses secret polynomials f(X) in R_{f} and g(X) in R_{g} .. The Prover computes the inverse of f(X) in the ring R, i.e., F(X)=f(X)⁻¹. The private key of the Prover is the polynomial f(X) and the public key of the Prover is the polynomial h(X)=F(X)*g(X). The Prover publishes the public key.

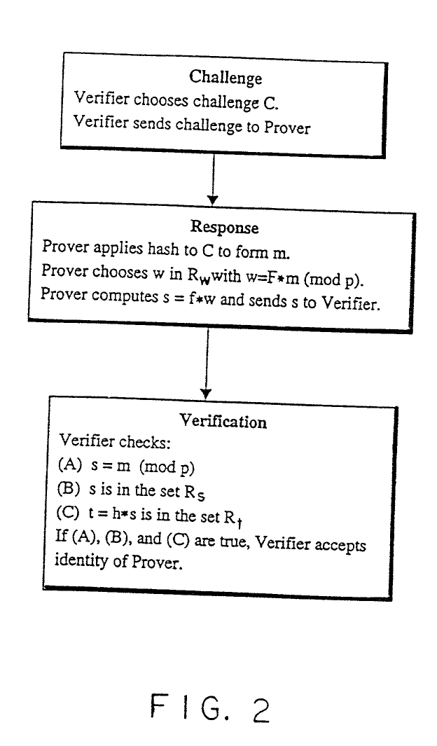

FIG. 2 illustrates an exemplary identification process. The Verifier initiates the Challenge Phase by generating a challenge C and sending, it to the Prover. The Prover initiates the Response Phase by applying a hash function to the challenge C to form a polynomial m(X) in Rₘ. The Prover also forms a polynomial w(X) in R_{w} having the form w(X)=m(X)+w₁(X)+pw₂(X), where w₁(X) and w₂(X) are polynomials in R_{w} that are chosen to prevent security attacks based on accumulation of large numbers of identifiers from the Provider (see example in Appendix 1, attached hereto, which is hereby incorporated by reference). The Prover computes the response polynomial s(X)=f(X) * w(X) modulo q and sends s(X) to the Verifier. The Verifier initiates the Verification Phase by applying the hash function to C to form the polynomial m(X).

The Verifier conducts the following two tests:

(1) Does s(X) modulo p differ from e_{f}X) * m(X) modulo p in at least D_{s,min} coefficients and in at most D_{s,max} coefficients?

(2) Compute t(X)=h(X) * s(X) modulo q. Does t(X) modulo p differ from e_{g}(X) * m(X) modulo p in at least D_{t,min} coefficients and in at most D_{t,max} coefficients?

D_{s,min} , D_{s,max} , D_{t,min} and D_{t,max} are predetermined numbers. The Verifier accepts the Prover as legitimate if the response polynomial s(X) transmitted by the Prover passes the two tests.

The following is an example of an embodiment of an identification scheme in accord with an embodiment of the present invention. Very small numbers are used in the example for ease of illustration. Thus, this example would not be cryptographically secure. However, in conjunction with the example there are described operating parameters that will provide a practical cryptographically secure cryptosystem under current conditions. Further discussion of the operating parameters to achieve a particular level of security is set forth in Appendix 1, which also describes the degree of immunity of an embodiment of the identification scheme to various types of attack.

The numbers used by the identification scheme are integers modulo an integer such as q. This means that each integer is divided by q and replaced by its remainder. For example, if q=7, then the number 39 would be replaced by 4, because 39 divided by 7 equals 5 with a remainder of 4. The objects used by the identification scheme are polynomials of degree N−1:

a₀+a₁X+a₂X²+. . .+a_{N-1}X^{N-1}

where the coefficients a₀, . . . , a_{N-1} are integers modulo q. Polynomial multiplication in a ring uses the extra rule that X_{N} is replaced by 1, and X_{N-1} is replaced by X^{N-1} and X_{N+2} is replaced by X², and so on. In mathematical terms, this version of the identification scheme uses the ring of polynomials with mod q coefficients modulo the ideal consisting of all multiples of the polynomial X^{N}−1. More generally, one can use polynomials modulo a different ideal or, even more generally, one could use some other ring. The basic definitions and properties of rings and ideals can be found, for example, in Topics in Algebra, I. N. Herstein, Xerox College Publishing, Lexington, Mass., 2^{nd} edition, 1975.

It is sometimes convenient to represent a polynomial by an N-tuple of numbers {a₀, a₁, . . . ,a_{N-1}}. In this situation, the product in the ring R becomes a convolution product. Convolution products can be computed very efficiently using Fast Fourier Transforms.

A sample multiplication using N=6 and q=7 is illustrated below.

(5+X+2X³+X⁴+3X⁵) * (3+X²+2X³+4X⁴+X⁵) =15+3X+5X²+17X³+25X⁴+20X⁵+6X⁶+13X⁷+12X⁸+13X⁹+3X¹⁰

(use the rule X⁶=1, X⁷=X, X⁸=X², X⁹=X³, X¹⁰=X⁴)

=21+16X+17X²+30X³+28X⁴+20X⁵

(reduce the coefficients modulo 7)

2X+3X²+2X³+6X⁵

For a cryptographically secure system, it is preferred to use, for example, N=251 and q=128. Larger values for N and q will provide more security, but will require more computational power and/or more time for computations.

Polynomials whose coefficients consist entirely of 0's, I's and -I's play a special role in the identification scheme. (In some embodiments of the invention, one might prefer a different range of coefficients.) The polynomials with only 0's, l's and −1's as coefficients are called trinary polynomials. For example,

1+X²−X³+X⁵−X¹¹

is a trinary polynomial. In practice, one preferably can also specify how many 1's and −1's are allowed in the polynomial. Let T(d) be the set of trinary polynomials of degree at most N−1 that have exactly d coefficients equal to 1 and exactly d coefficients equal to −1 and the remaining N−2d coefficients equal to 0.

In an identification scheme in accord with one embodiment of the present invention (using for illustration only the previously indicated small numbers), the first step is to choose integer parameters N, p and q. An illustrative set of such integer parameters is

N=17, p=3, q=32.

For a cryptographically secure system, it is preferred to use, for example, N=25 1, p=3 and q=128.

The first step also includes choosing deviation bounds D_{s,min} , D_{s,max} , D_{t,min}, and D_{t,max}. An illustrative set of deviation bounds is

D_{s,min}=2, D_{s,max}=6, D_{t,min}=3, D_{t,max}=7.

For a cryptographically secure system, it is preferred to use, for example, D_{s,min}=55, D_{s,max}=87, D_{t,min}=55 and D_{t,max}=87.

The first step further includes choosing sets of bounded coefficient polynomials R_{f} , R_{g} , R_{w}. The set R_{f} typically will consist of polynomials of the form f(X)=e_{f}(X)+pf₁(X), the set R_{g} typically will consist of polynomials of the form g(X)=e_{g}(X)+pf₁(X) and the set R_{w} typically will consist of polynomials of the form W(X)=M(X)+w₁(X)+pw₂(X) where, preferably, e_{f}(X) and e_{g}(X) are small polynomials such as, e.g., 1 and 1-2X, f₁(X) is chosen from the set T(df), g₁(X) is chosen from the set T(dg), w₁(X) is chosen from the set T(dw₁), and w₂(X) is chosen from the set T(dw₂). The polynomial m(X) is chosen using the hash of the challenge and, preferably, is chosen from the set T(dm). An illustrative set of values is

df=4, dg=3, dw₁=1, dW₂=2, dm=2.

For a cryptographically secure system, it is preferred to use, for example, df=35, dg=20, dw₁=12, dw₂=20 and dm=32.

The Prover chooses random polynomials f(X) and g(X) in the sets R_{f} and R_{g} . Illustrative polynomials are

e_{f}=1

f₁(X)=X¹⁶+X¹⁰−X⁸+X⁷−X⁶−X⁵−X²+1

f(X)=1+3f₁(X)=3X¹⁶+3X¹⁰−3X⁸+3X⁷−3X⁶−3X⁵−3X²+5

and

e_{g}=1-2X

g₁(X)=X¹⁵+X¹³−X¹¹+X¹⁰−X²−1

g(X)=1-2X+3g₁(X)=3X¹⁵+3X¹³−3X¹¹+3X¹⁰+3X²−2X−2

The Prover computes the inverse of f(X), i.e., F(X)=f(X)⁻¹.

F(X)=−14X¹⁶−7X¹⁵−3X¹⁴−9X¹³+15X¹²−9X¹¹−10X¹⁰+4X⁹−9X⁸+2X⁷+11X⁶−2X⁵−2X⁵−2X⁴−14X³−8X²−2X−6

This inverse is easy to compute using the Euclidean algorithm and Newton iteration. See Appendix I for further details. The private key is the pair (f, F) and the public key is the polynomial

h(X)=F(X)*g(X)=10X¹⁶+5X¹⁵−X¹⁴−10X¹³+13X¹²−10X¹¹+3X¹⁰−7X⁹+16X⁸+15X⁷−13X⁶+12X⁵+12X⁵+X⁴+8X³+8X²+9X+4

The Verifier sends a challenge C to the Prover. The Prover applies a hash function to C to form a polynomial m(X), for example

m(X)=−X⁶+X⁵−X²+1

The Prover forms a random polynomial w(X) in the set R_{w}. (See Appendix 1 for additional details.) An illustrative formation of w(X) is

w₁(X)=X⁹−X³

w₂(X)=−X⁶+X⁴+X³−X

w=m(X)+w₁(X)+3w₂(X)=X⁹=4X⁶+X⁵=3X⁴=2X³−X²−3X+1

Next, the Prover computes the response s(X)=f(X).w(X) (mod q),

s(X)=−6X¹⁴−X¹⁴−9X¹³+3X¹²−5X⁹+12X⁷+13X⁶+15X⁵−14X⁴−6X³+2X²−15X−8

and sends it to the Verifier.

The Verifier first compares

s(X) (mod 3)=X⁴+X⁹+X⁶+X⁴−X²+1

and

e_{f}(X)*m(X)=−X⁶+X⁵−X²+1

where e_{f}(X)=1 and checks that at least D_{s,min} and no more than D_{s,max} of the coefficients are different. The illustrative polynomial has 5 differences, so it passes test (1).

Next the Verifier uses the public key h(X) to compute

t(X)=h(X)*s(X)=14X¹⁶−6X¹⁵−6X¹⁴+12X¹³+6X¹²−15X¹¹+X¹⁰−2X⁹−12X⁸+8X⁷−3X⁶−11X⁵+13X⁴+7X³+7X³+5X²+13X+16 (mod q)

The Verifier then compares

t(X)(mod 3)=−X¹⁶+X¹⁰+X⁹−X⁷+X⁵+X⁴+X³−X²+X+1

and

e_{g}(X)*m(X) (mod 3)=−X⁷+X⁵−X³−X²+X+1

where e_{g}(X)=1-2X and checks that at least D_{t,min} and no more than D_{t,max} of the coefficients are different. The illustrative polynomial has 5 differences, so it passes test (2).

Because the exemplary response s(X) passes tests (1) and (2), the Verifier accepts the identity of the Prover.

Any authentication scheme involving the steps of

Challenge/Response/Verification

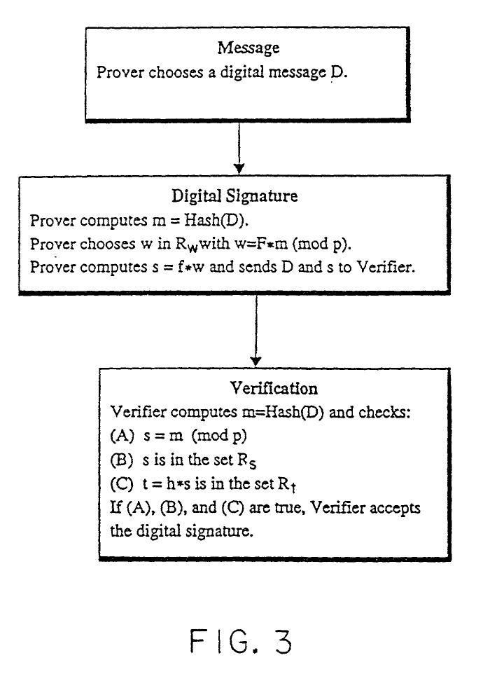

can be turned into a digital signature scheme. The basic idea is to use a hash function to create the challenge from the digital document to be signed. FIG. 3 illustrates an exemplary digital signature process in accord with the present invention. The steps that go into a digital signature are as follows:

Key Creation (Digital Signature)

The Signer creates the private signing key (f(X),F(X)) and the public verification key h(X) exactly as in the identification scheme.

Signing Step 1. Challenge Step (Digital Signature)

The Signer applies a hash function H to the digital document D that is to be signed to produce the challenge polynomial m(X).

Signing Step 2. Response Step (Digital Signature)

This is the same as for the identification scheme. The Signer forms w(X), computes s(X)=f(X)*w(X) (mod q), and publishes the pair (D, s(X)) consisting of the digital document and the signature.

Verification Step (Digital Signature)

The Verifier applies the hash function H to the digital document D to produce the polynomial m(X). The verification procedure is now the same as in the identification scheme. The Verifier tests that (1) s(X) mod p differs from e_{g}(X)*m(X) mod p in an appropriate number of places and that (2) t(X) mod p differs from e_{g}(X)*m(X) mod p in an appropriate number of places. If s(X) passes both tests, then the Verifier accepts the digital signature on the document D.

Hash functions are well known to those skilled in the art. The purpose of a hash function is to take an arbitrary amount of data as input and produce as output a small amount of data (typically between 80 and 160 bits) in such a way that it is very difficult to predict from the input exactly what the output will be. For example, it should be extremely difficult to find two different sets of inputs that produce the exact same output. Hash functions are used for a variety of purposes in cryptography and other areas of computer science.

It is a nontrivial problem to construct good hash functions. Typical hash functions such as SHA1 and MD5 proceed by taking a chunk of input, breaking it into pieces, and doing various simple logical operations (e.g., and, or, shift) with the pieces. This is generally done many times. For example, SHAI takes as input 512 bits of data, it does 80 rounds of breaking apart and recombining, and it returns 160 bits to the user. The process can be repeated for longer messages. For example, Federal Information Processing Standards Publication 180-1 (FIPS PUB 180-1), Apr. 17, 1995 issued by the National Institute of Standards and Technology describes the standard for a Secure Hash Algorithm, SHA-1, that is useful in the practice of the present invention. This disclosure of this publication is hereby incorporated by reference.

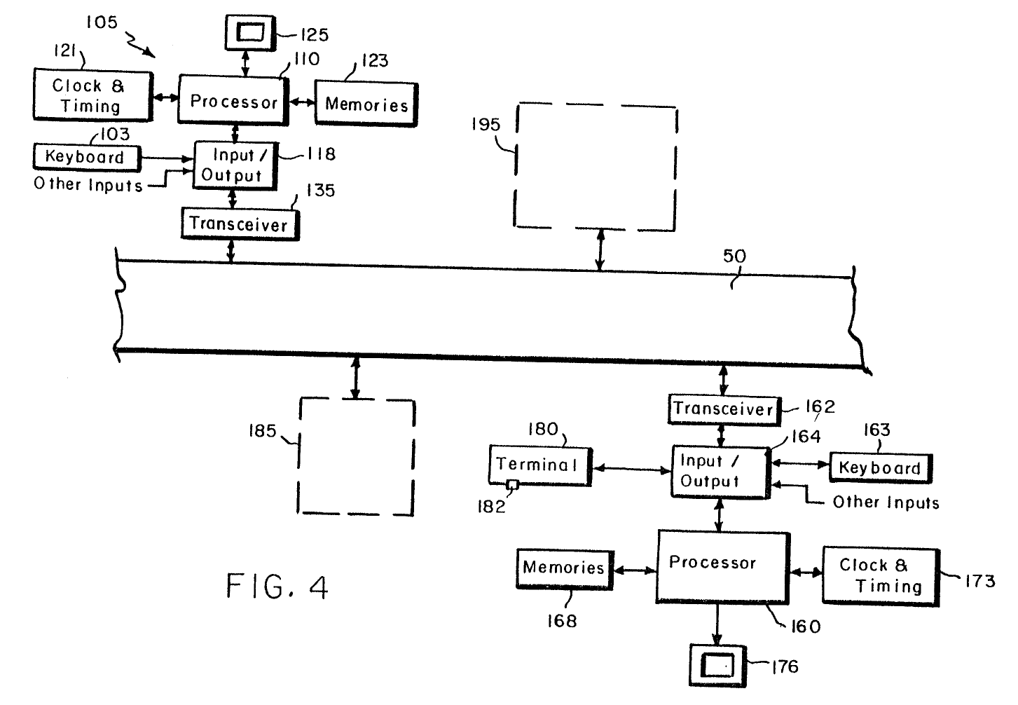

FIG. 4 is a block diagram illustrating a system that can be used to practice the methods of the present invention. A number of processor-based subsystems, represented at 105, 155, 185 and 195, are shown in communication over an insecure channel or network 50, which can be, for example, any wired, optical and/or wireless communication channel such as a telephone or internet communication channel or network. The subsystem 105 includes processor 110 and the subsystem 155 includes processor 160. When suitably programmed as described above, the processors 110 and 160 and their associated circuits and memory can be used to implement and practice the methods of the present invention. The processors 110 and 160 each can be any suitable processor such as, for example, a digital processor or microprocessor, or the like. It will be understood that any general purpose or special purpose processor, or other machine or circuitry that can perform the functions described herein, electronically, optically, or by other means, can be utilized to practice the methods of this invention. The processors can be, for example, Intel Pentium processors.

The subsystem 105 typically includes memories 123, clock and timing circuitry 121, input/output devices 118, and monitor 125, all of which are conventional devices. Input devices can include a keyboard 103 or any other suitable input device. Communication is via transceiver 135, which can include a modem, high speed coupler, or any suitable device for communicating signals. The subsystem 155 in this illustrative system can have a similar configuration to that of subsystem 105. Thus, the processor 160 also has associated input/output devices and circuitry 164, memories 168, clock and timing circuitry 173, and a monitor 176. Input devices include a keyboard 163 and any other suitable input device. Communication of subsystem 155 with outside devices is via transceiver 162, which can include a modem, high speed coupler, or any suitable device for communicating signals.

As represented in the subsystem 155, a terminal 181 can be provided for receiving a smart card 182 or other media. A “user” also can be a person's or entity's “smart card”, the card and its owner typically communicating with a terminal in which the card has been inserted. The terminal can be an intelligent terminal or a terminal communicating with an intelligent terminal. It will be understood that the processing and communication media described herein are merely illustrative and that the invention can have application in many other settings. The blocks 185 and 195 represent further subsystems on the channel or network.

The present invention has been described in conjunction with exemplary user identification and digital signature techniques carried out by a Prover and a Verifier in a communication network such as that illustrated in FIG. 4 wherein, for a particular communication or transaction, either subsystem can serve either role. It should be understood that the present invention is not limited to any particular type of application. For example, the invention can be applied to a variety of other user and data authentication applications. The term “user” can refer to both a user terminal as well as an individual using that terminal and, as indicated, the terminal can be any type of computer or digital processor suitable for directing data communication operations. The term “Prover” as used herein is intended to include any user that initiates an identification, digital signature or other secure communication process. The term “Verifier” as used herein is intended to include any user that makes a determination regarding the legitimacy or authenticity of a particular communication. The term “user identification” is intended to include identification techniques of the challenge/response type as well as other types of identification, authentication and verification techniques.

The user identification and digital signature techniques of the present invention provide significantly improved computational efficiency relative to the prior art techniques at equivalent security levels, while also reducing the amount of information which must be stored by the Prover and Verifier. It should be emphasized that the techniques described above are exemplary and should not be construed as limiting the present invention to a particular group of illustrative embodiments. Alternative embodiments within the scope of the appended claims will be readily apparent to those skilled in the art.

[image]

[image]

[image]

[image]

[image]

[image]

[image]

[image]

[image]

[image]

[image]

[image]

[image]

[image]

[image]

[image]

[image]

[image]

We claim:

1. A method for signing and verifying a digital message m, comprising the steps of:
selecting ideals p and q of a ring R;
generating elements f and g of the ring R;
generating an element F, which is an inverse of f, in the ring R;
producing a public key h, where h is equal to a product that can be calculated using g and F;
producing a private key that includes f;
producing a digital signature s by digitally “signing” the message m using the private key; and
verifying the digital signature by confirming one or more specified conditions using the message m and the public key h.

2. The method as defined by claim 1, wherein the digital signature s can be formed using the product of f and w modulo q, wherein w can be formed using the element m.

3. The method of claim 1, wherein a specified condition for verification of the digital signature s is that a quantity derived from s modulo p satisfies a specified relation with a quantity derived from m modulo p.

4. The method of claim 1, wherein a specified condition for verification of the digital signature s is that an element t of the ring R, which is formed from the product of the digital signature s and the public key h modulo q, satisfies a specified condition.

5. The method of claim 4, wherein a specified condition on the element t is that a quantity derived from t modulo p satisfies a specified relation with a quantity derived from m modulo p.

6. A method for signing and verifying a digital message m, comprising the steps of:
selecting integers p and q;
generating polynomials f and g;
determining the inverse F, where
F * f=1 (mod q);
producing a public key h, where
h=F * g (mod q);
producing a private key that includes f;
producing a digital signature s by digitally signing the message m using the private key; and
verifying the digital signature by confirming one or more specified conditions using the message m, the public key h, the digital signature s, and the integers p and q.

7. The method defined by claim 6, wherein the said polynomials f and g are produced as
f=e_{f}+pf₁ and g=e_{g}+pgᵢ
where e_{f}, e_{g}, fᵢ, and gᵢ are polynomials.

8. The method defined by claim 6, further comprising:
producing a polynomial was
w=m+w₁+pw₂
where w₁ and w₂ are polynomials; and
producing the signature s as
s=f * w(mod q).

9. The method defined by claim 7, further comprising:
producing the polynomial e_{f}* m (mod p); and
comparing the polynomials s (mod p) and e_{f}* m (mod p) to determine whether they satisfy one or more specified conditions.

10. The method defined by claim 7, further comprising:
producing the polynomial e_{f}* m (mod p); and
comparing the polynomials s (mod p) and e_{f}* m (mod p) to determine whether they have at least D_{s,min}, coefficients and no more than D_{s,max} coefficients that differ;
where D_{s,min} and D_{s,max} are integer values.

11. The method defined by claim 6, further comprising:
producing the polynomial t as
t=s * h modulo q; and
determining whether t satisfies one or more specified conditions.

12. The method defined by claim 11, further comprising:
producing the polynomial e_{g}* m (mod p);
wherein the comparing step determines whether the polynomials t (mod p) and e_{g}* m (mod p) satisfy one or more specified conditions.

13. The method defined by claim 11, further comprising:
producing the polynomial e_{g}* m (mod p);
wherein the comparing step determines whether the polynomials t (mod p) and e_{g}* m (mod p) have at least D_{t,min} coefficients and no more than D_{t,max} coefficients that differ;
where D_{t,min} and D_{t,max} are integer values.

14. The method as defined in claim 6, the method further comprising:
producing the digital signature by a first user at one location,
transmitting the digital signature to another location, and
verifying the digital signature by a second user at said another location.

15. The method as defined in claim 6, further comprising: selecting a monic polynomial M(X); and
when multiplying polynomials, first performing ordinary multiplication of polynomials and then dividing the result by M(X) and retaining only the remainder.

16. The method as defined in claim 6, further comprising:
selecting a non-zero integer N; and
when multiplying polynomials, reducing exponents modulo N.

17. The method defined in claim 6, further comprising restraining said polynomials f, g, and m to have bounded coefficients.

18. The method defined in claim 8, further comprising restraining said polynomials f, g, m, w₁ and w₂ to have bounded coefficients.

19. A method for authenticating the identity of a first user by a second user, the method including a challenge communication from the second user to the first user, a response communication from the first user to the second user, and a verification by the second user, the method comprising the steps of:
selecting ideals p and q of a ring R;
generating elements f and g of the ring R;
generating an element F, which is an inverse of f, in the ring R
producing a public key h, where h is a product that can be produced using g and F;
producing a private key including f and F;
generating a challenge communication by the second user that includes selection of a challenge m in the ring R;
generating a response communication by the first user that includes computation of a response s in the ring R, where s is a function of m and f; and
performing a verification by the second user that includes confirming one or more specified conditions using the response s, the challenge m and the public key h.

20. The method as defined by claim 19, further comprising;
generating element w of the ring R using the element m;
wherein the response s comprises the product of f and w modulo q.

21. The method of claim 19, further comprising comparing a first quantity derived from s modulo p with a second quantity derived from m modulo p to determine whether specified condition is satisfied.

22. The method of claim 19,
producing a polynomial t as
t=h * s; and
determining whether a quantity derived from t modulo p satisfies a specified relation with a quantity derived from m modulo p.

23. A method for authenticating the identity of a first user by a second user, the method including a challenge communication from the second user to the first user, a response communication from the first user to the second user, and a verification by the second user, the method comprising the steps of:
selecting integers p and q;
generating polynomials f and g;
determining the inverse F, where
F * f=I (mod q);
producing a public key h, where
h=F * (mod q);
producing a private key that includes f,
generating a challenge communication by the second user that includes selection of a challenge m;
generating a response communication by the first user that includes computation of a response s, wherein s is produced using m and f; and
performing a verification by the second user that includes confirming one or more specified conditions using the response s, the challenge m, the public key h, and the integers p and q.

24. The method defined by claim 23, wherein the said polynomials f and g are produced as
f=e_{f}+p_{f}, and g=e_{g}+pg₁
where e_{f}, e_{g}, f₁, and g₁ are polynomials.

25. The method defined by claim 23, further comprising:
producing a polynomial was
w=m+w₁+pw₂
where w₁ and w₂ are polynomials; and
producing the response s as
s=f * w(mod q).

26. The method defined by claim 23, further comprising:
producing the polynomial e_{f}* m (mod p); and
comparing the polynomials s (mod p) and e_{f}* m (mod p) to determine whether they satisfy one or more specified conditions.

27. The method defined by claim 23, further comprising:
producing the polynomial e_{f}* m (mod p); and
comparing the polynomials s (mod p) and e_{f}* m (mod p) to determine whether they have at least D_{s,min}, coefficients and no more than D_{s,max} coefficients that differ;
where D_{s,min} and D_{s,max} are integer values.

28. The method defined by claim 23, further comprising:
producing the polynomial t as
t=s * h modulo q; and
determining whether t satisfies one or more specified conditions.

29. The method defined by claim 28, further comprising:
preparing the polynomial e_{g}* m (mod p);
wherein the comparing step determines whether the polynomials t (mod p) and e_{g}*m (mod p) satisfy one or more specified conditions.

30. The method defined by claim 28, further comprising:
preparing the polynomial e_{g}* m (mod p);
wherein the comparing step determines whether the polynomials t (mod p) and e_{g}* m (mod p) have at least D_{t,min} coefficients and no more than D_{t,max} coefficients that differ;
where D_{t,min} and D_{t,max} are integer values.

31. The method as defined in claim 23, the method further comprising:
producing the response by a first user at one location,
transmitting the response to another location, and
verifying the response by a second user at said another location.

32. The method as defined in claim 23, further comprising:
selecting a monic polynomial M(X); and
when multiplying polynomials, first performing ordinary multiplication of polynomials and then dividing the result by M(X) and retaining only the remainder.

33. The method as defined in claim 23, further comprising:
selecting a non-zero integer N; and
when multiplying polynomials, reducing exponents modulo N.

34. The method defined in claim 23, further comprising restraining said polynomials f, g, and m to have bounded coefficients.

35. The method defined in claim 25, further comprising restraining said polynomials f, g, m, w₁ and w₂ to have bounded coefficients.

36. A system for signing and verifying a digital message m, the system comprising:
means for selecting ideals p and q of a ring R;
means for generating elements f and g of the ring R;
means for generating an element F, which is an inverse of f, in the ring R;
means for producing a public key h, where h is equal to a product that can be calculated using g and F;
means for producing a private key that includes f;
means for producing a digital signature s by digitally “signing” the message m using the private key; and
means for verifying the digital signature by confirming one or more specified conditions using the message m and the public key h.

37. A system for signing and verifying a digital message m, the system comprising:
means for selecting integers p and q;
means for generating polynomials f and g;
means for determining the inverse F, where
F * f=I (mod q);
means for producing a public key h, where
h=F * g (mod q);
means for producing a private key that includes f,
means for producing a digital signature s by digitally signing the message m using the private key; and
means for verifying the digital signature by confirming one or more specified conditions using the message m, the public key h, the digital signature s, and the integers p and q.

38. A system for authenticating the identity of a first user by a second user, including a challenge communication from the second user to the first user, a response communication from the first user to the second user, and a verification by the second user, the system comprising:
means for selecting ideals p and q of a ring R;
means for generating elements f and g of the ring R;
means for generating an element F, which is an inverse of f, in the ring R
means for producing a public key h, where h is a product that can be produced using g and F;
means for producing a private key including f and F;
means for generating a challenge communication by the second user that includes selection of a challenge m in the ring R;
means for generating a response communication by the first user that includes computation of a response s in the ring R, where s is a function of m and f; and
means for performing a verification by the second user that includes confirming one or more specified conditions using the response s, the challenge m and the public key h.

39. A system for authenticating the identity of a first user by a second user, including a challenge communication from the second user to the first user, a response communication from the first user to the second user, and a verification by the second user, the system comprising:
means for selecting integers p and q;
means for generating polynomials f and g;
means for determining the inverse F, where
F * f=1 (mod q);
means for producing a public key h, where
h=F * g (mod q);
means for producing a private key that includes f;
means for generating a challenge communication by the second user that includes selection of a challenge m;
means for generating a response communication by the first user that includes computation of a response s, wherein s is produced using m and f; and
means for performing a verification by the second user that includes confirming one or more specified conditions using the response s, the challenge m, the public key h, and the integers p and q.

40., A computer readable medium containing instructions for performing a method for signing and verifying a digital message m, the method comprising the steps of:
selecting ideals p and q of a ring R;
generating elements f and g of the ring R;
generating an element F, which is an inverse of f, in the ring R;
producing a public key h, where h is equal to a product that can be calculated using g and F;
producing a private key that includes f;
producing a digital signature s by digitally “signing” the message m using the private key; and
verifying the digital signature by confirming one or more specified conditions using the message m and the public key h.

41. A computer readable medium containing instructions for performing a method for signing and verifying a digital message m, comprising the steps of:
selecting integers p and q;
generating polynomials f and g;
determining the inverse F, where
F * f=I (mod q);
producing a public key h, where
h=F * g (mod q);
producing a private key that includes f;
producing a digital signature s by digitally signing the message m using the private key; and
verifying the digital signature by confirming one or more specified conditions using the message m, the public key h, the digital signature s, and the integers p and q.

42. A computer readable medium containing instructions for performing a method for authenticating the identity of a first user by a second user, the method including a challenge communication from the second user to the first user, a response communication from the first user to the second user, and a verification by the second user, the method comprising the steps of:
selecting ideals p and q of a ring R;
generating elements f and g of the ring R;
generating an element F, which is an inverse of f, in the ring R
producing a public key h, where h is a product that can be produced using g and F;
producing a private key including f and F;
generating a challenge communication by the second user that includes selection of a challenge m in the ring R;
generating a response communication by the first user that includes computation of a response s in the ring R, where s is a function of m and f; and
performing a verification by the second user that includes confirming one or more specified conditions using the response s, the challenge m and the public key h.

43. A computer readable medium containing instructions for performing a method for authenticating the identity of a first user by a second user, the method including a challenge communication from the second user to the first user, a response communication from the first user to the second user, and a verification by the second user, the method comprising the steps of:
selecting integers p and q;
generating polynomials f and g;
determining the inverse F, where
F * f=1 (mod q);
producing a public key h, where
h=F * g(mod q);
producing a private key that includes f;
generating a challenge communication by the second user that includes selection of a challenge m;
generating a response communication by the first user that includes computation of a response s, wherein s is produced using m and f; and
performing a verification by the second user that includes confirming one or more specified conditions using the response s, the challenge m, the public key h, and the integers p and q.
